(19) United States
(12) Patent Application Publication
(10) Pub. No.: US 2016/0291129 A1
(43) Pub. Date: Oct. 6, 2016

(54) Current-Mode Matched Filter Architecture For Signal Acquisition

(71) Applicants: The Regents of The University of Michigan, Ann Arbor, MI (US); Isocline Engineering, LLC, Ann Arbor, MI (US)

(72) Inventors: Michael B. HENRY, Ann Arbor, MI (US); Dennis SYLVESTER, Ann Arbor, MI (US); Bharan GIRIDHAR, San Jose, CA (US); David T. BLAAUW, Ann Arbor, MI (US); Laura FREYMAN, Ann Arbor, MI (US); David Alan FICK, Ann Arbor, MI (US)

(21) Appl. No.: 14/617,457

(22) Filed: Feb. 9, 2015

(51) Int. Cl. G01S 7/292; G01S 19/37

(52) U.S. Cl. CPC G01S 7/292; G01S 19/37

(57) ABSTRACT

A matched filter is provided for signal processing applications such as GNSS and RADAR. The filter includes a plurality of correlator cells configured to receive a digital signal and are arranged so that values of the digital signal can be shifted amongst the plurality of correlator cells. Each correlator cell includes a correlator circuit, a data source and a current source. The correlator circuit is configured to receive a value from the digital signal and operates to correlate the value with a value of the known pattern stored in the data store. The current source is interfaced with the correlator circuit and selectively sources current based on the correlation operation performed by the correlator circuit; and an output circuit is coupled to each of the plurality of correlator cell and operates to generate an output which is correlated to current that is being source collectively by the current sources.

### GOVERNMENT CLAUSE

This invention was made with government support under DGE1256260 awarded by the National Science Foundation, and FA8650-13-C-1606 awarded by the US Air Force/AFRL. The Government has certain rights in the invention.

### FIELD

The present disclosure relates to a current-mode matched filter architecture used for digital signal processing (DSP) applications such as global navigation satellite systems (GNSS) or radio detection and ranging (RADAR).

### BACKGROUND

A matched filter is a signal processing construct used to detect the presence of a known signal pattern within a received signal that is obscured by noise. The core operation of a matched filter is correlation, which is a dot product operation of a local replica of the pattern with the received signal. Correlation of two identical patterns results in a spike in signal energy at the output of the summation, whereas correlation of any signal with a random signal—i.e. noise —yields no increase in energy. Thus, if the pattern is present in the received signal and aligned with the local replica in the time domain, a spike in signal to noise ratio at the detector is seen. Many matched filter implementations include a scheme to search incoming data for the pattern in the time domain to find the correct alignment. For example, the pattern may be held constant while the incoming signal is sent through a shift register.

Several popular technologies rely on matched filters in their operation. Code-division-multiplex access (CDMA) receivers use patterns known as spreading codes to modulate a data transmission. In the specific case of an N-length binary spreading code, the bandwidth of the signal is increased by a factor of N, while the spectral power is reduced by a factor of N. The benefits of CDMA include the ability to share a frequency allocation among multiple simultaneous transmitters, and increased resilience to narrow-band interference. Global navigation satellite systems (GNSS), including the U.S. Global Positioning System (GPS), are a special case of CDMA. In addition to the previous benefits, GNSS systems leverage the inherent time synchronization that comes with matching a local pattern to a received pattern. GNSS receivers use matched filters to synchronize to a set of satellites, measure the relative transmission delay, and calculate the user's position. Other applications include radar, where matched filters are used to detect objects in the presence of unwanted reflected signals, and image processing applications such as X-ray.

In technologies such as GNSS, long binary CDMA codes are used with lengths of at least 1023 bits and transmit rates of at least 1.023 MHz; longer codes minimize inter-satellite interface and maximize the resolution of the time synchronization (and therefore position accuracy). The resulting decrease in spectral power from the frequency spreading is large enough that the signal appears to the receivers to be below the noise floor and undetectable. Through application of the matched filter, however, the SNR at the detector increases above the noise floor and the signal becomes detectable.

Matched filters can be implemented in hardware using a variety of methods. Using GNSS as an example, if the correct time synchronization between the receiver and the GNSS satellites is known, then a time domain search of the spreading pattern offset in the received signal is not needed. A simple multiply-accumulate register is needed to correlate the received signal with the pattern—and indeed this is the most common implementation in a GNSS receiver when the time synchronization is known and is being actively maintained. This is called tracking in satellite receivers.

If the time synchronization is not known in a GNSS receiver, then a time domain search is needed to determine the correct time-domain alignment in the matched filter between the local replica spreading pattern and the received pattern. Because the signal is below the noise floor, it cannot simply be examined—the matched filter must be used to increase the SNR above the noise floor at the signal detector. In the case of the GPS legacy civilian code, a 1023 bit spreading code is used and all possible rotations of that code must be correlated. Newer GNSS standards use much longer codes and in military receivers, the code does not repeat, so many more time-steps must be correlated. This requires an enormous amount of computation in a receiver whose users demand position lock times on the order of seconds, so many high performance matched filter hardware implementations have been invented which are directly applicable to the signal acquisition portion of GNSS.

High performance matched filter hardware typically involves two array of storage elements, one that is stationary, and one that is shifted in order to perform the time-domain search. At each shift offset, a correlation is performed whereby the two arrays are compared or multiplied with each other, and the result at each array element is summed together. The multiplication or comparison can typically be implemented using a small number of gates; it is the summation and shifting that is challenging to implement in a traditional digital microchip solution. The summation involves the addition of a large number of elements, so a correspondingly large number of adder cells are required to form the summation adder tree. This adder tree must span the entire storage array, so routing and interconnects is a challenge and the energy overhead is large due to the excessive wire capacitance.

This disclosure addresses these issues by replacing the sprawling digital summation with a current-mode approach that reduces the wiring congestion to a single shared wire. At each sample point in the correlation, the multiplication result is converted to a current and connected to a common node. The currents naturally sum on this shared wire via Kirchhoff's Current Law (KCL), and the resulting current summation can be read by a properly designed output circuit. In addition to the reduction of wiring congestion, this strategy also enables a grid-based layout of cells similar to memories. Thus, these cells can be additionally optimized to reduce power and increase performance well beyond a standard digital design created with automatic place and route tools. Therefore, not only is the routing congestion reduced, but the remaining digital portions of the acquisition system are also now optimized. By using an optimized grid-based layout couple digital sampling with current-mode computation, a much larger system is possible than before. The resulting loss of accuracy due to replacing a digital summation with a current-mode summation is minor, and is more than offset by the improvements of performance, efficiency, and scale of the system. Using this strategy, a design was produced for a 262144 sample acquisition system, which is both 64 times larger and 64 times faster than a 4096 sample system (a standard design in this area), as well as more energy efficient.

This section provides background information related to the present disclosure which is not necessarily prior art.

### SUMMARY

This section provides a general summary of the disclosure, and is not a comprehensive disclosure of its full scope or all of its features.

A matched filter is provided for signal processing applications such as GNSS and RADAR. The filter includes a plurality of correlator cells configured to receive a digital signal and are arranged so that values of the digital signal can be shifted amongst the plurality of correlator cells. Each correlator cell includes a correlator circuit, a data source and a current source. The correlator circuit is configured to receive a value from the digital signal and operates to correlate the value with a value of the known pattern stored in the data store. In other arrangements, values of the known pattern are shifted amongst the correlator cells and the value from the digital signal is stored in the data store. The current source is interfaced with the correlator circuit and selectively sources current based on the correlation operation performed by the correlator circuit; and an output circuit is coupled to each of the plurality of correlator cells and operates to generate an output which is correlated to current that is being source collectively by the current sources.

In one embodiment, the data store is implemented with a register, the correlator circuit is implemented with an XOR gate, and the current source is implemented by a transistor.

In some embodiments, a current switch is interposed between the current source and the common wire and selectively enables the current source to source current based on the correlation operation performed by the correlator circuit. The current switch may be implemented by a transistor that is interfaced with the correlator circuit to selectively turned on to source current onto the common wire.

In one embodiment, the output circuit operates to maintain voltage at the common node constant. For example, the output circuit can be further defined as at least one of an operational amplifier or an operational transconductance amplifier.

In other embodiments, the output circuit includes a reset circuit electrically coupled to the common node and operates to set voltage at the common node to a predefined value; and a read circuit electrically coupled to the common node and operates to measure voltage at the common node.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a diagram depicting an example of a matched filter;

FIG. 2 is a diagram depicting an example correlator cell;

FIG. 3 is a diagram depicting an example embodiment of a correlator cell;

FIG. 4 is a diagram depicting another example embodiment of a correlator cell;

FIG. 5 is a diagram depicting yet another example embodiment of a correlator cell;

FIG. 6 is a diagram depicting an example embodiment of an output circuit;

FIG. 7 are waveforms illustrating the computation sequence using the output circuit of FIG. 6;

FIG. 8 is a diagram depicting another example embodiment of an output circuit;

FIG. 9 are waveforms illustrating the computation sequence using the output circuit of FIG. 8;

FIG. 10 is a diagram depicting an example arrangement for a full acquisition system;

FIG. 11 is a diagram depicting one sector of the acquisition system;

FIG. 12 is a diagram depicting one bank in a sector of the acquisition system;

FIG. 13 is a diagram depicting a portion of the acquisition system with a switched network between sectors; and

FIG. 14 is a diagram illustrating a technique for shifting data within a sector of the acquisition system.

Corresponding reference numerals indicate corresponding parts throughout the several views of the drawings.

### DETAILED DESCRIPTION

Example embodiments will now be described more fully with reference to the accompanying drawings.

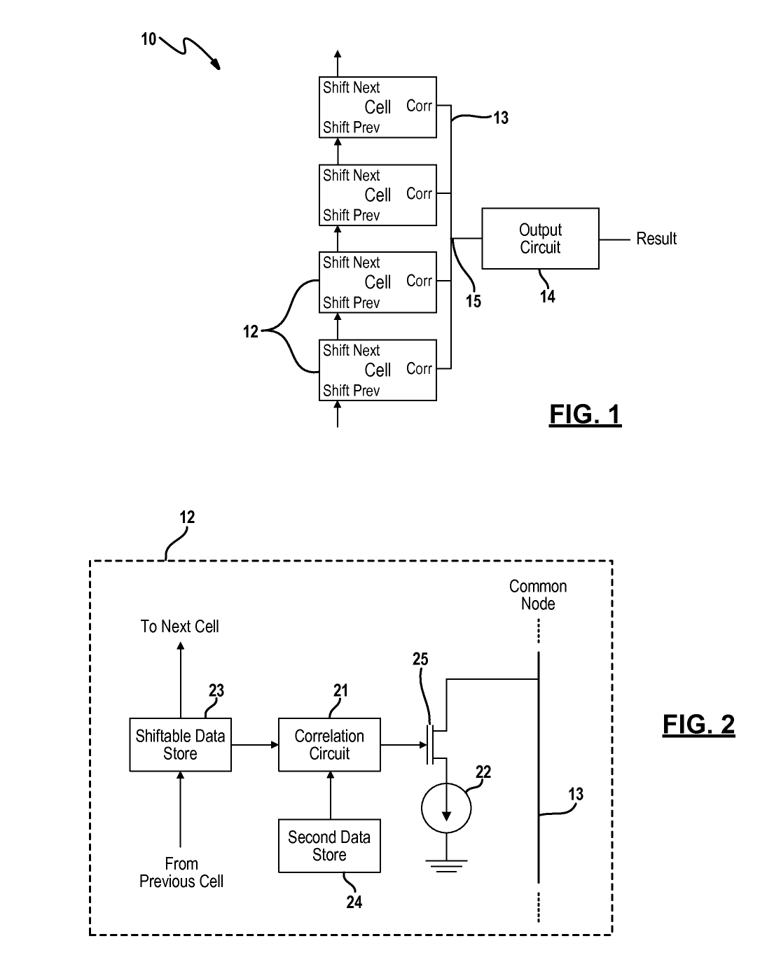

FIG. 1 depicts an example of a matched filter 10. The matched filter 10 is comprised generally of a plurality of correlator cells 12 connected by a common wire 13 to an output circuit 14. The correlator cells 12 are arranged so that data can be shifted amongst the cells. More specifically, each correlator cell further includes two data ports for shifting data between the cells and the correlator cells 12 are connected in series to each other via the data ports. Current output on the common wire 13 is naturally summed. The output circuit 14 is coupled at a common node 15 to each of the plurality of correlator cells 12. The resulting current summation is in turn converted to an output by the output circuit 14.

Components of a correlator cell 12 are depicted in FIG. 2. Each correlator cell 12 includes a correlator circuit 21, a selectable current source 22, a current switch 25 and at least two data stores 23, 24. The correlator circuit 21 is configured to receive a value from an incoming digital signal and correlate the value of the digital signal with the value of a known pattern. The current source 22 is configured to selectively source current onto the common wire 13. To do so, a current switch 25 is interposed between the current source 22 and the common wire 13. The current switch 25 is also interfaced with the correlator circuit 21 and selectively enables the current source to source current in accordance with the correlation between the value from the incoming digital signal and the value of the known pattern. That is, when the value of the incoming digital signal correlates with the value of the known pattern, the current switch 25 is closed and the current source 25 sources current onto the common wire 13. Conversely, when the value of the incoming digital signal does not correlate with the value of the known pattern, the current switch remains open, thereby preventing current from being source onto the common wire 13.

In one embodiment, the value from the incoming digital signal is stored in a shiftable data store 23; whereas, the value of the known pattern is stored in a second data store 24. Values in the shiftable data store 23 may be shifted from cell to cell as further described below. In an alternative embodiment, the value from the incoming digital signal is stored in the second data store 24 and the value of the known pattern is stored in the shiftable data store 23. Typically, the unknown data is shifted since that lends itself naturally to an incoming stream of RF data, however, in some applications, it is more energy efficient to shift the known pattern data, for example because the RF data has more bits per sample than the pattern data. In some embodiments, the second data store can also be implemented with a shift chain.

In some embodiments, it is desirable to have differential signaling, which can have benefits including increased performance in greater noise immunity. To implement differential signaling, there needs to be two common nodes instead of one, where the currents sourced to the two common nodes are opposite (e.g., common_pos and common_neg). To make this conversion, the signals enabling/disabling the current sources instead are now selecting whether a current should be sourced to common_pos or instead to common_neg. This strategy helps keep current sources in a consistent state since they are always used (i.e., current steering), which aides performance and accuracy. The output circuit also needs to be modified to accept differential input currents, which should be readily realized by someone skilled in the art.

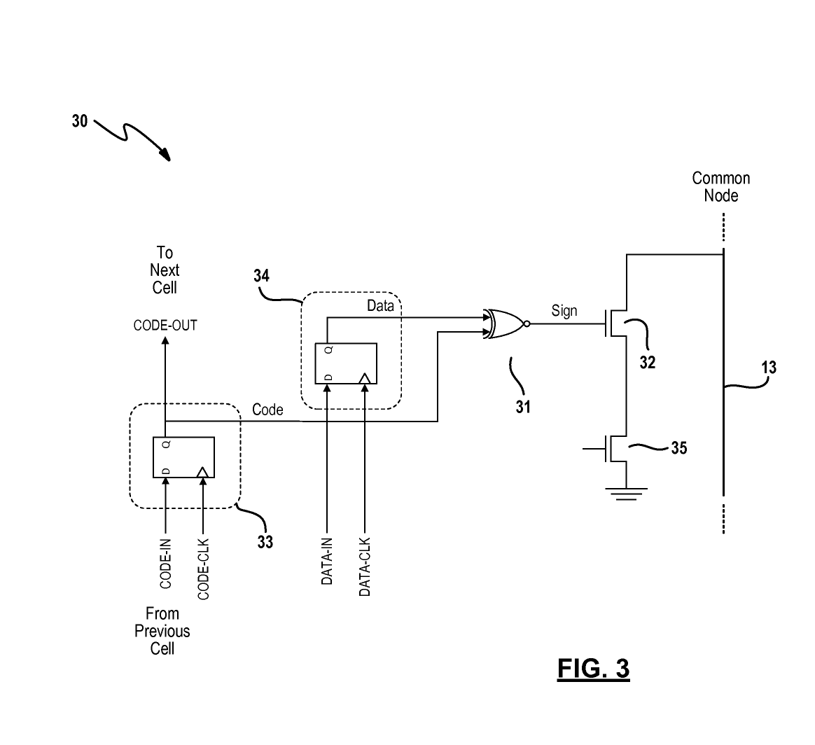

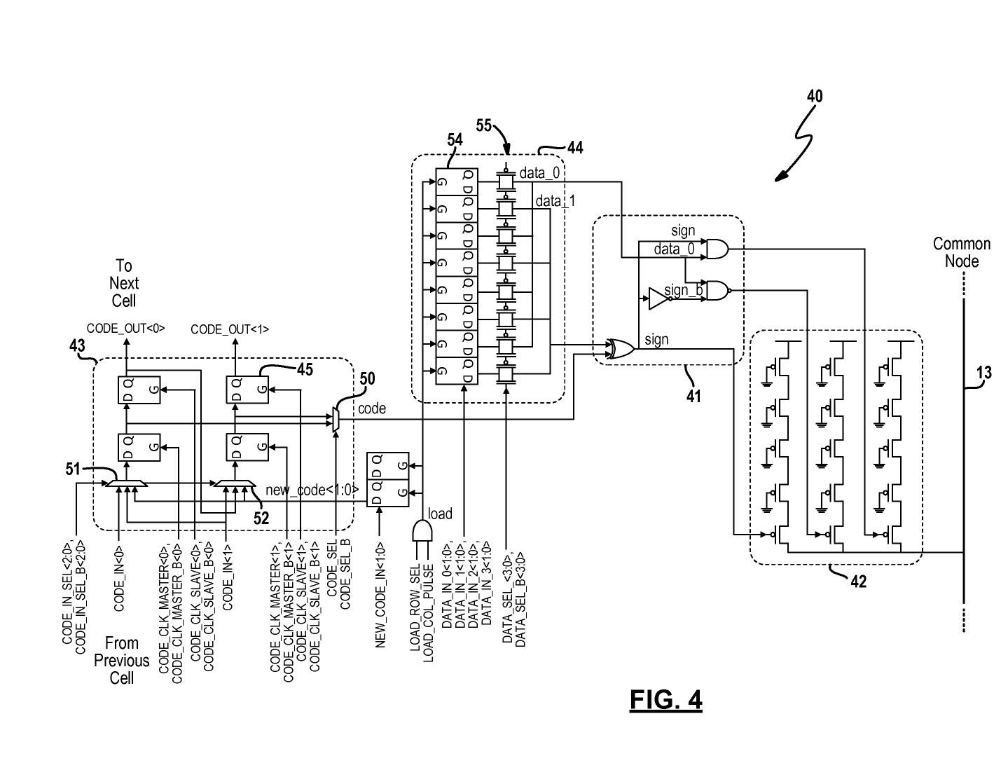

FIG. 3 depicts an example embodiment of a correlator cell 30. In this embodiment, the correlation operation is performed by an XNOR gate 31 and the current switch is implemented by a transistor 32, such as a PMOS transistor. The current source may also be implemented by a transistor 35. The shiftable data store 33 and the second data store 34 are each implemented by a single register. The shiftable data store 33 is connected to the adjacent correlator cells so as to form a shift chain within the matched filter. During operation, XNOR gate 31 turns on the transistor 32 when the value in the shiftable data store 33 correlates with the value in the second data store 34 (i.e., both values are one or both values are zero) and thereby enables the current source 35 to source current onto the common wire 13. Conversely, the XNOR gate 31 turns off the transistor 32 when the value in the shiftable data store 33 does not correlate with the value in the second data store 34.

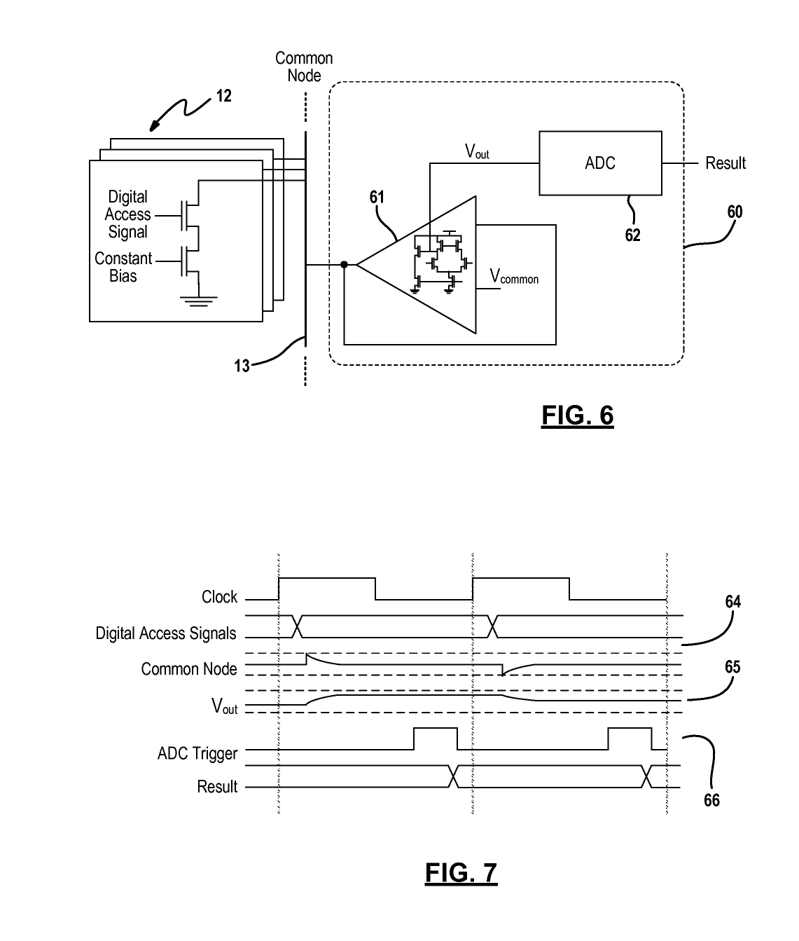

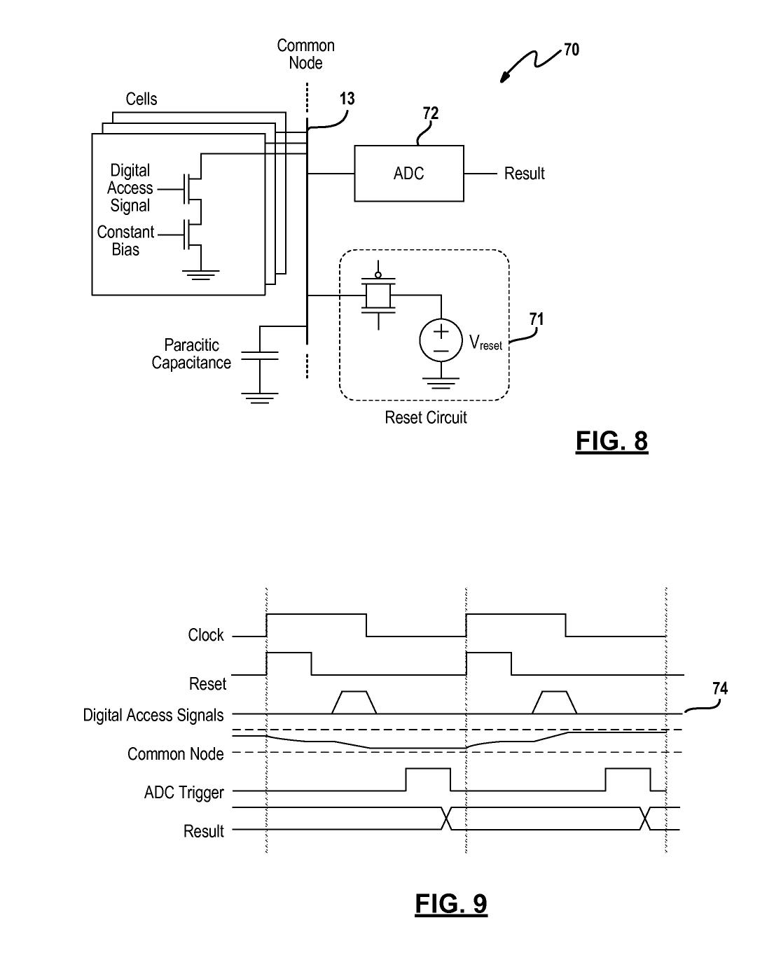

In an alternative embodiment, the current switch 32 is omitted and the current source is implemented by a single transistor, such as a PMOS transistor. In this example, the correlation operation is performed by a XOR gate but otherwise this embodiment operates as described above. While example output circuits are further described below, it is noted that this correlator cell 30 is best paired with the output circuit shown in FIG. 6 although it could also work with the output circuit shown in FIG. 8 if the reset circuitry is sufficiently strong.

FIG. 4 depicts a more complex example embodiment for a correlator cell 40. This embodiment is suitable for applications such as global navigation satellite systems (GNSS). For example, this embodiment is suitable for the M-code which is comprised of four RF samples: in-phase and quadrature samples for an upper band and a lower band. Each sample may be represented by two bits. In this embodiment, values for a known spread sequence code are stored in the shiftable data store 43 and samples from an incoming RF signal are stored in the second data store 44. While particular reference is made to the M-code, it is readily understood that the concepts described herein are applicable to other types of spread sequence codes such as a coarse/acquisition code and p(y) code.

More specifically, the shiftable data store 43 is configured to store two different codes and thus is comprised of four latches 45. The latches use a master-slave latching scheme which separates two clocks and was found to be simpler to implement. A multiplexer 50 enables selection of one of the two codes such that multiple satellites can be searched in parallel. Two additional multiplexers 51, 52 enable the two codes to be combined into one long code. Shifting the code instead of the data was chosen in this case because there are two code bits but eight data bits, resulting in a 75% decrease in shifting energy and area.

The second data store 44 is configured to store four samples with each sample being represented by two bits. In this case, eight latches 54 are used to store the samples. Latches can be used instead of registers due to their lower overhead. The second data store 44 further includes a selection circuit 55 which enables one of the four samples to be input to the correlator circuit 42. In an example embodiment, the selection circuit 55 is implemented by two 4×1 transmission gate multiplexers. Since each cell would be selecting the same storage location, the signals controlling the selection circuit (that is, the signals going to the gates of the transmission gates) can be shared between the cells. Additional circuitry may be used to facilitate storing the next code in the shiftable data store 43 or writing of the data to the second data store 44.

In operation, the correlator circuit 41 correlates a selected one of the four RF samples with one of the codes stored in the shiftable data store 43. In an example embodiment, the correlation result is encoded as a thermometer code having values −3, −1, 1 or 3, which map to the digital numbers 0, 1, 2, 3 by adding three and dividing by two. For the RF samples, this mapping allows us to store the four numbers as a two bit value, and for the correlation result it allows us to represent the number by turning on zero, one, two, or three current sources in correlation circuit 42. The code selected by 50 is a single bit value representing −1 or 1. To perform the correlation, the correlation circuit 41 will perform a multiplication of the RF sample and the code value and map the result to a 0, 1, 2, 3 value which will enable 0, 1, 2, or 3 current sources. In an example embodiment, this multiplication and mapping can be performed with an AND gate, a NAND gate, a NOT gate and an XOR gate.

In the example embodiment, the current source circuit 42 is further defined by three parallel circuit paths, where each circuit path has at least one transistor interfaced with an output of the correlator circuit 41 although each path may be comprised of multiple transistors to reduce the amount of current draw. Either zero, one, two or three of the circuit paths are turned on in accordance with the value of the thermometer code, thereby outputting a current onto the common wire. Likewise, it is noted that correlator cell 40 is best paired with the output circuit shown in FIG. 6 but could also work with the output circuit shown in FIG. 8 if the reset circuitry is sufficiently strong.

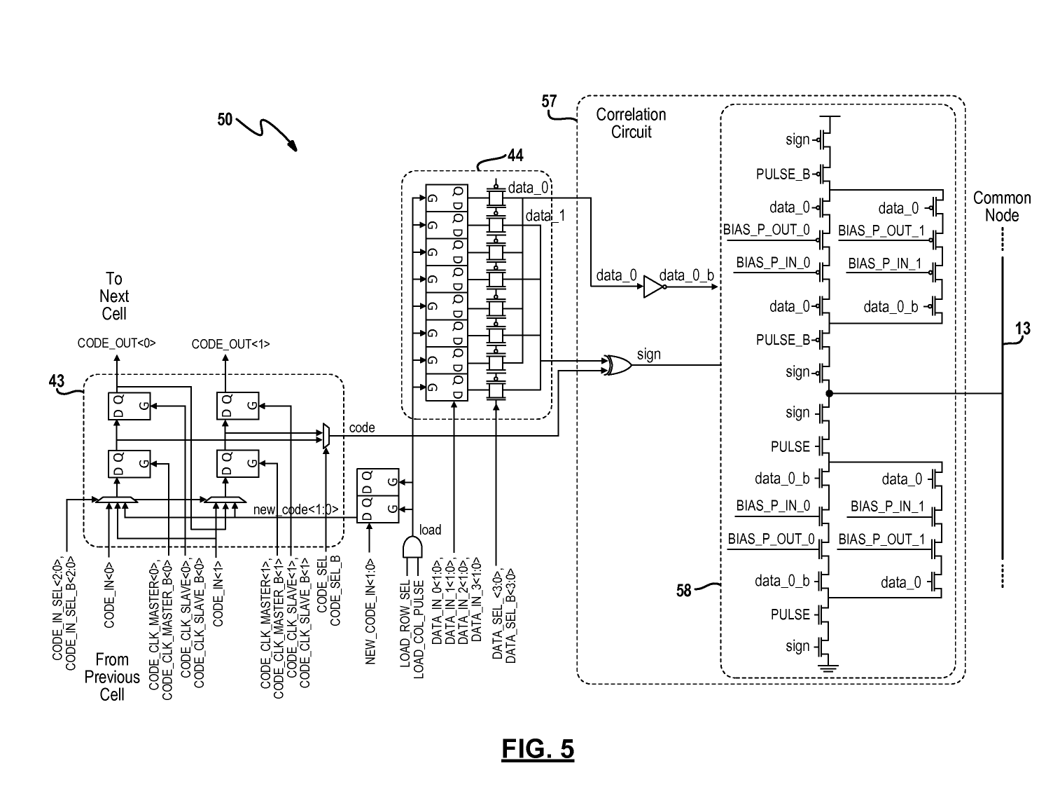

FIG. 5 depicts another example embodiment of a correlator cell 50. In this example, the current source circuit 42 generates output values −3, −1, 1 and 3 directly without the use of a thermometer code. As a result, one of four current sources is turned on in accordance with the correlation result. Current sources use a cascoded structure to improve output impedance and may include a pulse input so that the current sources can be turned on for a brief amount of time. Correlator cell 50 is best paired with output circuit in FIG. 8 but could also work with the output circuit in FIG. 6 as well. Except with respect to the differences discussed herein, the correlator cell 50 is substantially the same as correlator cell 40 described above in relation to FIG. 4.

FIG. 6 depicts an example embodiment of an output circuit for use in a matched filter 10. The output circuit 60 includes an operational transconductance amplifier (OTA) 61 and an analog-to-digital converter (ADC) 62. The operational transconductance amplifier which maintains a predetermined voltage on a common node 15. As the correlator cells 12 in the matched filter 10 change the amount of current sourced to/from the common node, the OTA 61 must change the amount of current that it is sourcing to offset the current from the correlator cells 12 and maintain the common node voltage. That amount of current sourced by OTA 61 can be determined in the form of a voltage tapped out from an internal node from the OTA, which can be read by the analog-to-digital convert 62 to generate the result.

Triggering of the computation in this example embodiment is further described in relation to FIG. 7. Each computation is performed on a clock cycle basis. In this example, the entire computation is performed in one clock cycle. At the beginning of the clock cycle, the common node voltage is at Vcommon, as indicated at 64, and the cells are each digitally correlating the stored digital data with the shifted digital data to create a correlation result, which selectively enables the local current source for that cell. As the number of selectively enabled current sources changes, the common node will rise or fall in voltage due to the mismatch in current being sourced from the cells and from the output circuitry. The output circuitry responds to change the amount of current it is sourcing in order to move the common node voltage back to Vcommon. As indicated at 65, the output circuitry has a second output node, Vout, which has a voltage related to the amount of current being sourced by the output circuitry. After Vout has stabilized, the ADC is triggered at 66 which converts the voltage on Vout to a digital result. The correlator cell embodiments in FIGS. 3 and 4 are a good match for this output circuit 60 and trigger method since they have low output impedance, so they benefit from the steady common node voltage, and they do not have a gating signal for the current sources, although that could be easily added.

FIG. 8 depicts another example embodiment of an output circuit 70 for use in a matched filter 10. In this embodiment, the output circuit 70 includes a reset circuit 71 which operates to set voltage at the common node to a predetermined value and a read circuit 72 which operates to measure voltage at the common node. In operation, the reset circuit 71 forces the common node voltage to a predetermined value and then disengages. As a result, the common node will charge or discharge, quickly or slowly, due to the selectable current sources in each of the correlation cells 12. The parasitic capacitance influences the charging rate based on the standard V=I*t/C capacitor equation. After the voltage has developed for some time, the read circuit will read the line voltage to derive an output. The read circuit 72 may be implemented, for example by an analog-to-digital converter.

FIG. 9 further illustrates an example computation sequence using output circuit 70. Likewise, the computation is performed on a clock cycle basis. In this example, the entire computation is performed in one clock cycle. At the beginning of the clock cycle, the common node is at an unknown voltage due to the computation from the previous cycle, so the reset circuitry is enabled long enough to bring the common node to ½ VDD. During the reset, the cells are each digitally correlating the stored digital data with the shifted digital data to create a correlation result, which will determined if its local current source will be enabled. After the reset is complete, the enabled subset of digital access signals are pulsed as indicated at 74 such that a subset of current sources are enabled for part of the cycle, and that subset of current sources add and/or remove charge from the common node, which makes the common node voltage ramp up or down during that time period, with the ramp slope related to the number of enabled current sources. Once the ramp is complete and the digital access signals are disabled, the ADC is triggered which converts the voltage on the common node to a digital result. In the example waveform diagrams two calculations are shown, the first with a negative correlation (ramp down) and the second with a positive correlation (ramp up). It is readily understood that there are many equivalent ways to design this circuit to achieve the same result, including changing the relative timing of the signal and the topology of the current sources. This output circuit 70 is best paired with the correlator cell in FIG. 5 due to its high output impedance, which enables the cells current sources to operate consistently over a wide voltage range, as well as that cells ability to shut off the current sources during reset.

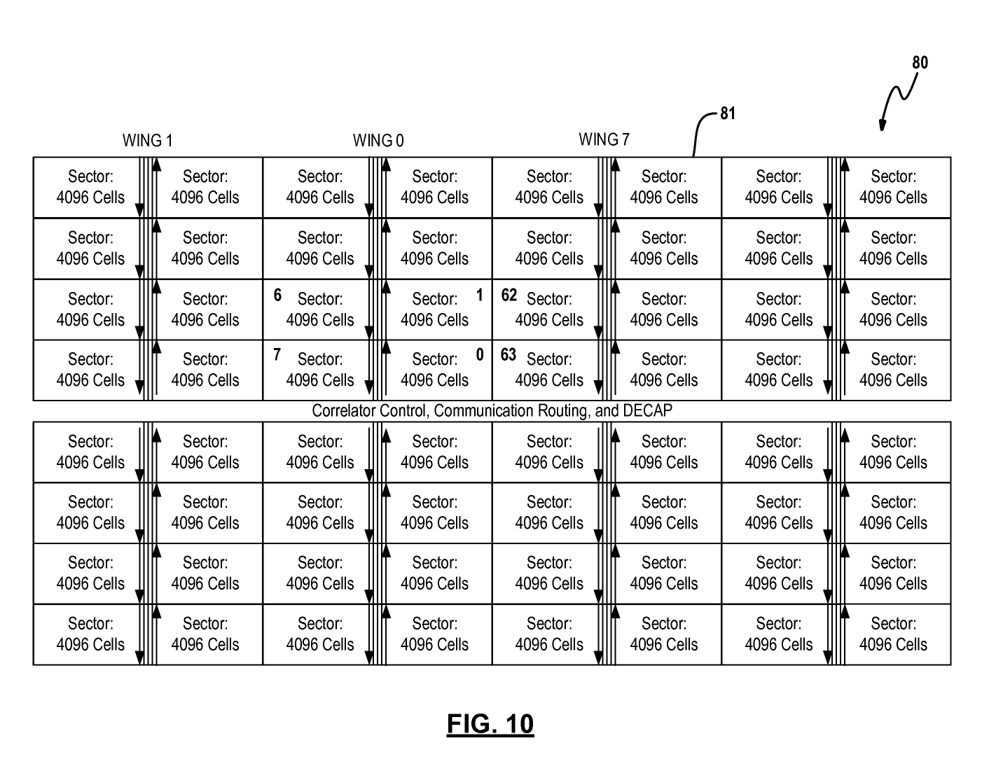

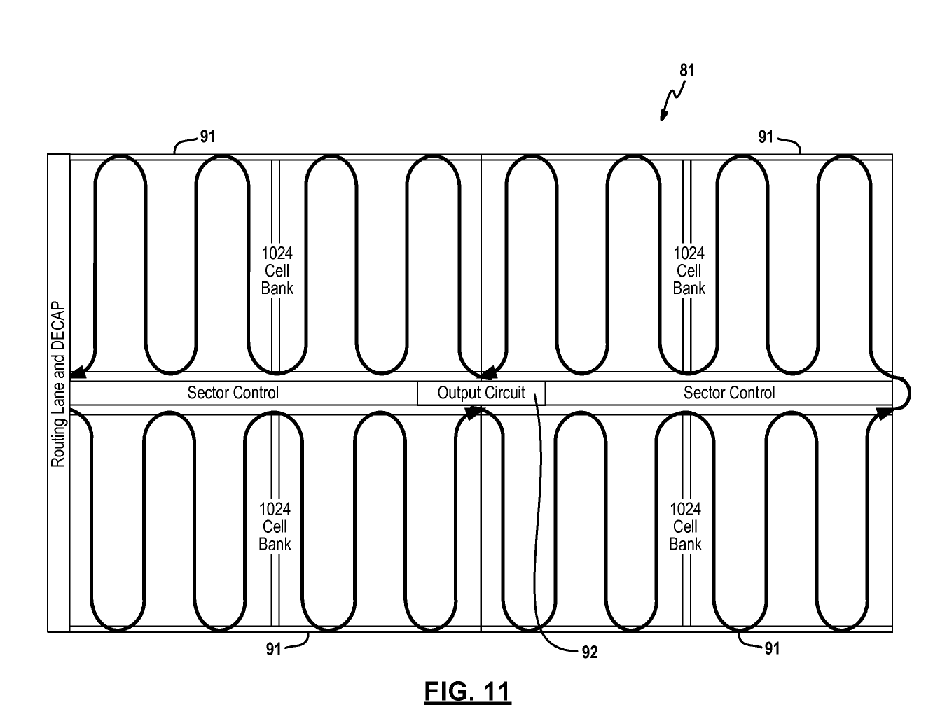

FIG. 10 depicts an example full acquisition system 80 meant for military GNSS acquisition. The system 80 includes 262144 correlation cells (not shown) arranged into 64 sectors 82. The 64 sectors are arranged so that the shifted data passes from one sector to the next. In one embodiment, each of the 64 sectors has its own output circuitry so that a Fast Fourier Transformation (FFT) can be performed on the resulting correlation. The common nodes of the sectors could also be connected together so that only a single common node exists and only a single output circuit is needed. There is substantial advantage to performing the FFT, however, which reduces the time of the frequency search component of signal acquisition. The sectors and banks each include enable signals which allows the system to reduce to a shorter correlation than 262144 if that is desirable. If only one bank for each sector is used, then the correlation is reduced by four times to 65536 samples.

FIG. 11 depicts a sector 81 with 4096 cells arranged into four banks 91. The sector 81 contains an output circuit 92 in the middle and some logic to operate the sector. The banks 91 are arranged so that the shifting data passes between the banks. During data writing, only one of the banks writes at a time.

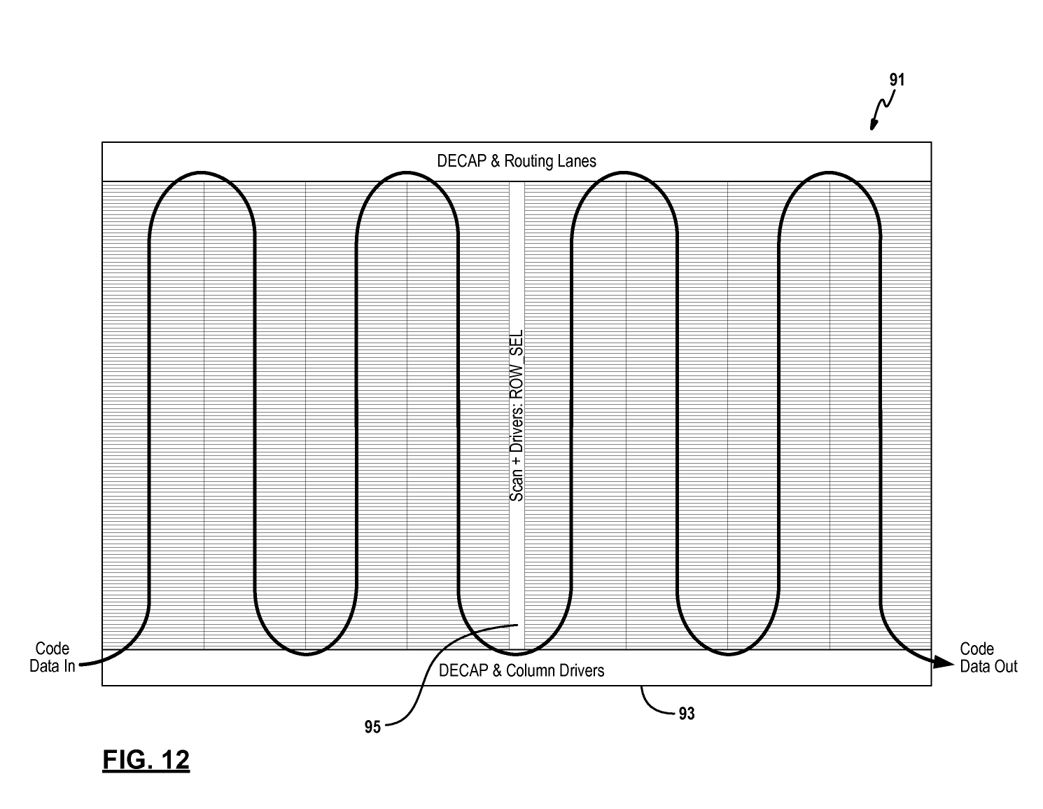

In FIG. 12, the cells 12 are arranged into a bank 91 in the form of a grid that has 8 columns and 128 rows for 1024 cells in the bank. The majority of the drivers 93 for the cells are placed at the bottom of the bank, with some row drivers 95 placed between the middle two columns. The cells are arranged so that the shifted data shifts in a snaking pattern up and down the columns. To write data to a cell in the array, the row drivers enable one row and the column drivers enable one column—the AND gate labeled “load” in FIGS. 4 and 5 combines those selections so that the enables to the stored data latches to a single cell are enabled. This strategy allows the efficient writing of one cell with minimal logic. The cells are designed to be wide and short in order to reduce wiring parasitics since the control signaling is vertical, other than the row enable for writing, and the number of wires needed for the common node in the bank is reduced to only eight. Other arrangements for an acquisition system fall within the broader aspects of this disclosure.

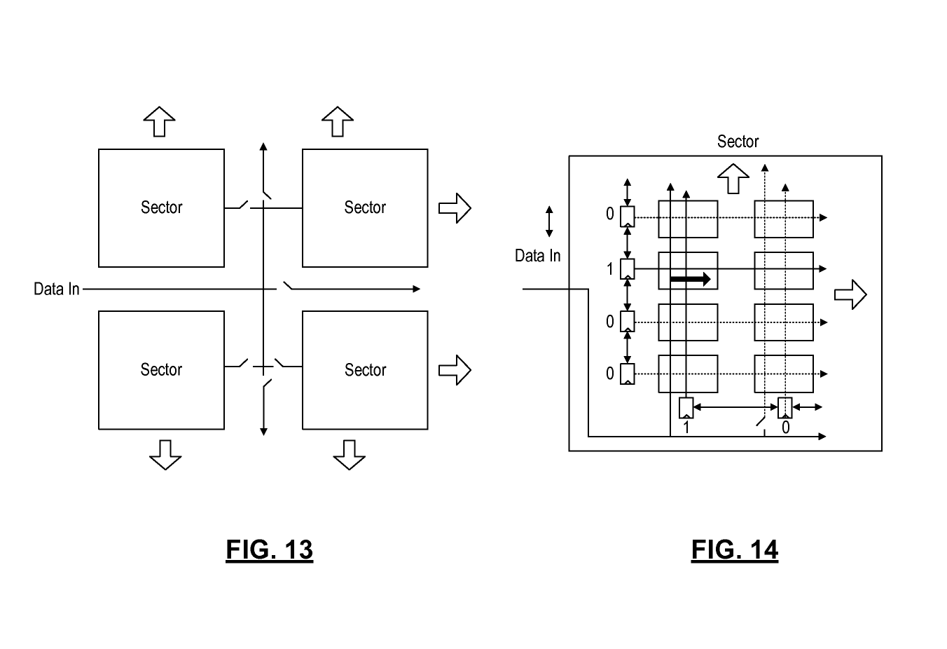

Another aspect of this disclosure relates to an efficient technique for shifting data amongst the correlation cells of a matched filter. A new signal value must be delivered from outside the acquisition architecture to any given point inside the physical structure. The acquisition architecture can be very large, so having a wire that traverses the entire structure would consume considerable power if it switched every clock cycle. Instead, a switched-network is used, where the wire is selectively gated as seen in FIG. 13. In FIG. 10, the acquisition architecture is shown broken up into sectors. The data-in wire is selectively gated so that the wire only switches on the path from the input to the sector receiving the data. Within a bank, a set of shift registers with a ‘1’ bubble is used for the rows and columns as shown in FIG. 14. The row ‘1’ shifts up towards the top of the column. When it reaches the top, the ‘1’ in the column shift chain shifts towards the right. The data-in line is again selectively gated so it only travels up the active column. During each clock cycle, whichever cell has a ‘1’ in both the row and column receives the data. In an example embodiment, the row and column signals actives the enable pin of latch, while a clock pulse turns the latch transparent. In this way, the amount of unnecessary switching is reduced.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A matched filter, comprising:
a plurality of correlator cells are configured to receive a digital signal and are arranged so that values of the digital signal can be shifted amongst the plurality of correlator cells, the plurality of correlator cells are interconnected by a common wire, each correlator cell includes a data store, a correlator circuit, and a current source,
wherein the data store stores one value of a known pattern,
wherein the correlator circuit is configured to receive a value from the digital signal and operates to correlate the value of the digital signal with the value of the known pattern,
wherein the current source is configured to selectively source current to the common wire based on the correlation operation performed by the correlator circuit, and
an output circuit coupled at a common node to each of the plurality of correlator cell and operates to generate an output which is correlated to current that is being sourced collectively by the current sources.

2. The matched filter of claim 1 wherein the data store is implemented with a register, the correlator circuit is implemented with an XOR gate, and the current source is implemented by a transistor.

3. The matched filter of claim 1 further comprises a current switch is interposed between the current source and the common wire and selectively enables the current source to source current based on the correlation operation performed by the correlator circuit.

4. The matched filter of claim 3 wherein the current switch is implemented by a transistor that is interfaced with the correlator circuit to selectively turn on the source current.

5. The matched filter of claim 1 wherein the output circuit operates to maintain voltage at the common node constant.

6. The matched filter of claim 5 wherein the output circuit is further defined as at least one of an operational amplifier or an operational transconductance amplifier.

7. The matched filter of claim 1 wherein the output circuit includes
a reset circuit electrically coupled to the common node and operates to set voltage at the common node to a predefined value; and
a read circuit electrically coupled to the common node and operates to measure voltage at the common node.

8. The matched filter of claim 1 further comprises a shifted data store that stores one value of the digital signal.

9. The matched filter of claim 1 wherein the data store stores one value of the digital signal and the shifted data store stores one value of the known pattern.

10. A signal processing apparatus for performing pattern matching, comprising:
a plurality of correlator cells interconnected by a common wire and configured to receive an RF signal, each correlator cell includes a correlator circuit, a stored data store, a shifted data store, and a current source circuit,
wherein the shifted data store stores one value from either the RF signal or a known pattern, and the stored data store stores one value from the other of the RF signal or the known pattern,
wherein the correlator circuit is configured to receive the value from shifted data store and the value from the stored data store and operates to correlate the value from the shifted data store with the value from the stored data store,
wherein the current source circuit is interfaced with the correlator circuit and outputs a current onto the common wire in accordance with the correlation between the value from the shifted data store and the value from the stored data store, such that current is output onto the common wire when the value from the shifted data store and the value from the stored data store match and current is not output onto the common wire when the value from the shifted data store and the value from the stored data store match do not match or vice versa; and
an output circuit coupled at a common node to each of the plurality of correlator cells and operates to generate an output which is indicative of quantity of current that is being source collectively from the plurality of correlator cells.

11. The signal processing apparatus of claim 10 wherein the current source circuit is implemented by a current source that selectively sources current onto the common wire and a transistor interfaced with the correlation circuit to selectively turn on the current source in accordance with input from the correlation circuit.

12. The signal processing apparatus of claim 10 wherein the shifted data store and the stored data store are implemented by latch circuits, such that a first shifted latch circuit stores a value from a known pattern and a first stored latch circuit stores a sample from the RF signal.

13. The signal processing apparatus of claim 12 wherein shifted data store further includes a second shifted latch circuit that stores a value from a second known pattern which differs from the known pattern.

14. The signal processing apparatus of claim 13 further comprises a multiplexer interfaced between the correlator circuit and the first shifted latch circuit and the second shifted latch circuit to enable selection of one of the first shifted latch circuit and the second shifted latch circuit.

15. The signal processing apparatus of claim 14 wherein the stored data store is configured to store four or more samples of the RF signal.

16. The signal processing apparatus of claim 15 further includes a selection circuit interfaced between the correlator circuit and the stored data store and operable to select one of the samples of the RF signal to be input to the correlator circuit.

17. The signal processing apparatus of claim 16 wherein the current source circuit include three circuit paths coupled in parallel with each other, each of the three circuit paths having at least one transistor interface with the correlator circuit, and the correlator circuit selectively turns on transistors in the three circuit paths in accordance with the correlation result.

18. The signal processing apparatus of claim 10 wherein the output circuit operates to maintain voltage at the common node constant.

19. The signal processing apparatus of claim 18 wherein the output circuit is further defined as at least one of an operational amplifier or an operational transconductance amplifier.

20. The signal processing apparatus of claim 10 wherein the output circuit includes
a reset circuit electrically coupled to the common node and operates to set voltage at the common node to a predefined value; and
a read circuit electrically coupled to the common node and operates to measure voltage at the common node.

21. A signal processing apparatus for acquiring spread spectrum signals, comprising:
a plurality of correlator cells interconnected by a common wire and configured to receive an RF signal, each correlator cell includes a correlator circuit, a stored data store, a shifted data store, and a current source circuit,
wherein the shifted data store stores one value from either the RF signal or a known spread sequence code, and the stored data store stores one value from the other of the RF signal or the known spread sequence code,
wherein the correlator circuit is configured to receive the value from shifted data store and the value from the stored data store and operates to correlate the value from the shifted data store with the value from the stored data store,
wherein the current source circuit is interfaced with the correlator circuit and outputs a current onto the common wire in accordance with the correlation between the value from the shifted data store and the value from the stored data store; and
an output circuit coupled at a common node to each of the plurality of correlator cells and operates to generate an output which is indicative of quantity of current that is being sourced collectively from the plurality of correlator cells.

22. The signal processing apparatus of claim 21 wherein the plurality of correlator cells are arranged so that values of the digital signal can be shifted amongst the plurality of correlator cells.

23. The signal processing apparatus of claim 21 wherein the shifted data store stores a value from a known spread sequence code and the stored data store stores a value from the RF signal.

24. The signal processing apparatus of claim 23 wherein the stored data store is configured to store four samples of the RF signal and each sample is represented by two bits.

25. The signal processing apparatus of claim 24 wherein the stored data store is implemented by eight latch circuits.

26. The signal processing apparatus of claim 25 further includes a selection circuit interfaced between the correlator circuit and the stored data store and operable to select one of the four samples of the RF signal to be input to the correlator circuit.

27. The signal processing apparatus of claim 26 wherein the current source circuit include three circuit paths coupled in parallel with each other, each of the three circuit paths having at least one transistors interfaced with the correlator circuit, and the correlator circuit selectively turns on transistors in the three circuit paths in accordance with the correlation result.

28. The signal processing apparatus of claim 27 wherein the output circuit operates to maintain voltage at the common node constant.

29. The signal processing apparatus of claim 28 wherein the output circuit is further defined as at least one of an operational amplifier or an operational transconductance amplifier.

30. The signal processing apparatus of claim 29 wherein the known spread sequence code is selected from a group consisting of a coarse/acquisition code, a p(y) code and a m-code.

31. The signal processing apparatus of claim 29 resides in a device configured to receive global positioning signals from one or more satellites.
